(19) United States
(12) Patent Application Publication
(10) Pub. No.: US 2023/0179406 A1
(43) Pub. Date: Jun. 8, 2023

(54) Distributed Registration and Authentication via Threshold Secret Sharing

(71) Applicant: VMware, Inc., Palo Alto, CA (US)

(72) Inventors: Avishay Yanai, Herzliya (IL); Alex Markuze, Herzliya (IL); Igor Golikov, Herzliya (IL)

(21) Appl. No.: 17/543,513

(22) Filed: Dec. 6, 2021

(51) Int. Cl. H04L 9/08

(52) U.S. Cl. CPC H04L 9/085; H04L 9/0869

(57) ABSTRACT

Techniques for implementing distributed registration and authentication (i.e., the collaborative processing of client registration and authentication requests by multiple nodes in a computing system) via threshold secret sharing are provided. A threshold secret sharing scheme is a cryptographic method for sharing a secret among N parties in a manner that requires at least T+1 of the N parties to cooperate in order to reconstruct/reveal the secret, where T is some threshold value less than N. By leveraging threshold secret sharing, these techniques enable a group of N nodes to efficiently implement distributed registration and authentication in a correct, secure, and privacy-preserving fashion, even if up to T of the N nodes are corrupted by an adversary.

### BACKGROUND

Unless otherwise indicated, the subject matter described in this section is not prior art to the claims of the present application and is not admitted as being prior art by inclusion in this section.

Computing systems that provide applications/services to clients (e.g., email systems, social media platforms, Software-as-a-Service (SaaS) systems, etc.) typically implement (1) a registration procedure that enables new clients to submit registration requests and thereby register themselves with the system, and (2) an authentication procedure that enables registered clients to submit authentication requests and thereby authenticate themselves (or in other words, login) to the system. Among other things, these registration and authentication procedures allow different clients to be associated with different privileges, preferences, persistent state, and so on with respect to the provided applications/services.

In scenarios where each registration and authentication request submitted by a client is processed independently by a single machine (i.e., node) of the computing system (referred to herein as “single-node registration and authentication”), the implementation of (1) and (2) is straightforward. For example, with respect to (1), a node can receive a registration request from a new client that includes an email address and password; transmit some secret information (e.g., a verification code) in an email to the submitted email address; receive the secret information back from the client (thereby verifying that the client is the owner of the email address); and create a registration entry for the client comprising the email address and password (or a hash of the password). With respect to (2), a node can receive an authentication request from a client that includes an email address and password; check whether the submitted password matches the password included in a registration entry keyed by the submitted email address; and if this check is successful (which indicates that the client has been successfully authenticated), grant the client access to the system.

Unfortunately, single-node registration and authentication is highly vulnerable to attacks by adversaries and is generally unable to guarantee correctness, security, or privacy for the registration and authentication procedures if just one node becomes corrupted. As used herein, the property of correctness means that honest (i.e., uncorrupted) clients can successfully complete registration and authentication, the property of security means that dishonest clients cannot login to the system using the passwords/credentials of other clients (or as non-registered clients), and the property of privacy means that the passwords/credentials of honest clients cannot be obtained by the adversary.

For example, assume there are three nodes S₁, S₂, and S₃ that each implement single-node registration and authentication and an adversary A corrupts (i.e., takes control of) S₁, while leaving S₂ and S₃ uncorrupted. In this scenario, because each node handles registration and authentication requests independently of the others, adversary A has free reign to censor clients (or other words, prevent clients from registering and authenticating) through S₁, impersonate clients (or in other words, login to the system using the passwords/credentials of other clients) through S₁, and perform other problematic actions, such as initiate an offline brute-force attack to try and obtain the plaintexts of hashed client passwords.

### BRIEF DESCRIPTION OF THE DRAWINGS

FIG. 1 depicts an example environment according to certain embodiments.

FIG. 2 depicts a distributed registration workflow according to certain embodiments.

FIG. 3 depicts a distributed authentication workflow according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

### 1. Overview

Embodiments of the present disclosure are directed to techniques for implementing distributed registration and authentication (i.e., the collaborative processing of client registration and authentication requests by multiple nodes in a computing system) via threshold secret sharing. A threshold secret sharing scheme is a cryptographic method for sharing a secret among N parties in a manner that requires at least T+1 of the N parties to cooperate in order to reconstruct/reveal the secret, where T is some threshold value less than N. One example of such a scheme is Shamir's secret sharing.

By leveraging threshold secret sharing, the techniques of the present disclosure enable a group of N nodes to efficiently implement distributed registration and authentication in a correct, secure, and privacy-preserving fashion, even if up to T of the N nodes are corrupted by an adversary (subject to certain constraints on T and the nature of the network interconnecting the nodes and clients). These and other aspects are described in further detail below.

### 2. Example Environment and High-Level Solution Design

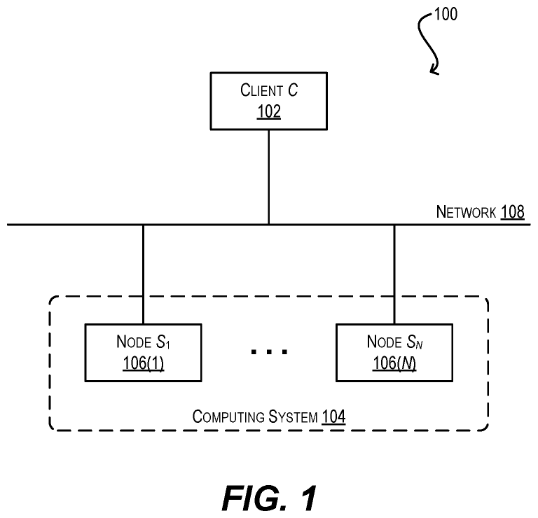

FIG. 1 depicts an example environment 100 in which embodiments of the present disclosure may be implemented. As shown, environment 100 includes a client C (reference numeral 102) that is communicatively coupled with a computing system 104 comprising N nodes S₁, . . . , S_{N} (reference numerals 106(1)-(N)) via a network 108. Generally speaking, the goal of nodes S₁, . . . , S_{N}—each of which may be any type of physical or virtual machine known in the art—is to register and authenticate clients like client C that wish to interact with computing system 104. Ideally, nodes S₁, . . . , S_{N} should implement these registration and authentication procedures in a manner that ensures correctness, security, and privacy in the face of attacks by an adversary.

As noted in the Background section, according to one approach known as single-node registration and authentication, each node S₁ can handle client registration and authentication requests independently. For example, if node S₁ receives a registration request from client C, S₁ can process that registration request in its entirety without any interaction or communication with other nodes. Similarly, if node S₂ receives an authentication request from client C after it has been registered via node S₁, S₂ can process that authentication request in its entirety without any interaction or communication with other nodes. However, this single-node approach quickly falls apart in the case where an adversary is able to take control of any individual node (i.e., S_{corrupted}) because the adversary can thereafter censor clients via S_{corrupted} (resulting in a loss of correctness), impersonate clients via S_{corrupted} (resulting in a loss of security), and mount an offline attack to invert hashed client passwords via S_{corrupted} (resulting in a potential loss of privacy).

To address the foregoing and other similar issues, embodiments of the present disclosure provide a distributed registration and authentication approach that enables nodes S₁ . . . , S_{N} of computing system 104 to process each client registration/authentication request in a collaborative manner. As mentioned previously, this distributed approach relies on a threshold secret sharing scheme like Shamir's secret sharing. Such a scheme involves splitting a secret s into a number of cryptographic portions or “shares” (also known as generating a “T-out-of-N sharing” of s, denoted as [s]) and distributing these shares among N parties. This allows, for example, the parties to carry out operations (e.g., secure multiparty computations) on secret s using their respective shares, while keeping s hidden from each party.

Significantly, threshold secret sharing guarantees that a coalition of up to T out of the N parties cannot learn secret s by colluding and disclosing their shares of the T-out-of-N sharing [s] to each other; instead, at least T+1 shares are needed to reconstruct/reveal s. For example, in the case of Shamir's secret sharing, each share sᵢ=p(i) where p is T-degree polynomial with p(0)=s. It is well known that such a T-degree polynomial theoretically hides the secret encoded at p(0) from any subset of at most T parties. In addition, threshold secret sharing schemes are linear in nature, which means that given two sharings [x] and [y] where each party i holds xᵢ and yᵢ, the parties can locally obtain the sharing [z] where z=aα+βy+γ for some arbitrary public values α,β, γ.

With the foregoing explanation of threshold secret sharing in mind, the distributed registration procedure of the present disclosure can generally proceed as shown below. It should be noted that in certain embodiments, this implementation assumes threshold value T is less than N/3, where T is the maximum number of nodes out of S₁, . . . , S_{N} that may be corrupted by an adversary (such that the adversary is able to control the node's internal state and network communications); all network messages passed between client C and nodes S₁, . . . , S_{N}, as well as between the nodes themselves, are secured from tampering and eavesdropping via a mechanism such as Transport Layer Security (TLS); and network 108 is synchronous, which means that if a receiver does not receive an expected network message from a sender within a bounded period of time, the receiver proceeds with its configured processing using a default message containing some predefined value (e.g., zero or null).
1. Client C sends a registration request to nodes S₁, . . . , S_{N} that includes a communication endpoint address (e.g., email address, telephone number, etc.) owned by C
2. Nodes S₁, . . . , S_{N} receive the registration request, generate a T-out-of- N sharing of a random secret value R (i.e., [R]) via a threshold secret sharing scheme and send their respective shares of [R] to client C
3. Client C reconstructs R using the received shares, generates a new T-out-of-N sharing of R (i.e., [R′]) via the threshold secret sharing scheme, and sends share R′ᵢ to each node S₁
4. Nodes S₁, . . . , S_{N} securely compute a difference (i.e., delta) between R and R′ using their original shares of [R] and the received shares of [R′] and, for each node S₁, if the delta equals zero, node S₁ stores a local registration entry for client C comprising the communication endpoint address and its share Rᵢ of [R]; otherwise, the node takes no action
5. Client C stores R as its authentication credential for logging into system 104

Further, the distributed authentication procedure of the present disclosure can generally proceed as shown below. In certain embodiments, the same constraints/assumptions noted with respect to the distributed registration procedure also apply to this distributed authentication procedure.
1. Client C generates a new T-out-of-N sharing of R (i.e., [R′]) via the threshold secret sharing scheme and sends an authentication request to each node S₁ that includes C's previously registered communication endpoint address and share R′ₜᵢ
2. Nodes S₁, . . . , S_{N} securely compute a delta between R and R′ using the received shares of [R′] and their original shares of [R] and for each node S₁, if the delta equals zero, node Sᵢ outputs a result (e.g., bit value, flag, etc.) indicating that C has been successfully authenticated by that node; otherwise, node Sᵢ outputs a result indicating that C has not been successfully authenticated by that node
3. System 104 grants access to client C if at least N— T of nodes S₁, . . . , S_{N} have successfully authenticated C per the results output at (2)

With these distributed implementations, client registration and authentication can be achieved while advantageously guaranteeing the properties of correctness, security, and privacy. For example, regarding correctness, an honest client will always be able to register and login by virtue of the characteristics of the threshold secret sharing scheme, as long as there are at most T corrupted nodes. Accordingly, an adversary cannot deny service or censor specific clients.

Regarding security, at the time a given client attempts to authenticate/login by submitting a communication endpoint address and a sharing [R′] based on its authentication credential R, if that address was not previously registered with the shares of [R] by nodes S₁, . . . , S_{N}, the delta computed by the nodes at step (2) of the distributed authentication procedure will not equal zero (for example, it may be undefined). Thus, each uncorrupted node will output a result indicating that the client has not been successfully authenticated, thereby denying access to the client.

And regarding privacy, because the original random value R generated at the time of registration is unknown to the nodes, the probability that an adversary guesses R is 1/IF where IF is the threshold secret sharing scheme's underlying field. With a large enough field, an adversary cannot feasibly guess R. Further, the distributed authentication procedure above makes it impossible to run an offline brute-force attack to guess R, as each guess (which requires the submission of an authentication request) involves processing/interaction by all nodes, S_{N}. Yet further, in certain embodiments the foregoing distributed registration and authentication procedures can be enhanced such that, at the time of securely computing the deltas at steps (4) and (2) respectively, nodes S₁, . . . , S_{N} can multiply each delta by a fresh random value Q. This enhancement, which is described in greater detail in sections (3) and (4) below, ensures that the nodes cannot learn anything regarding original random value R in the case where the client sends a sharing of a value R′ that is different from R.

### 3. Distributed Registration Workflow

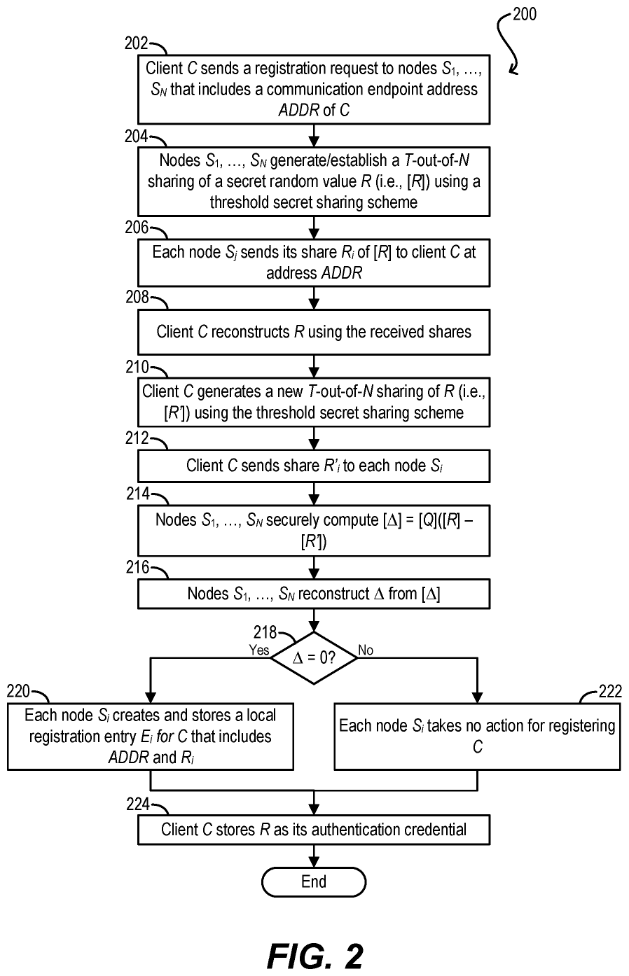

FIG. 2 depicts a workflow 200 that provides additional details regarding the processing that may be performed by client C and nodes S₁, . . . , S_{N} of FIG. 1 for implementing distributed registration via threshold secret sharing according to certain embodiments.

Starting with step 202, client C can send a registration request to nodes S₁, . . . , S_{N} that includes a communication endpoint address ADDR owned by C (or alternatively, owned by a user/individual operating C). This communication endpoint address can be, e.g., an email address, a telephone number, an ID/username associated with a messaging application, or the like.

At step 204, nodes S₁, . . . , S_{N} can receive the registration request and generate/establish a T-out-of-N sharing of a secret random value R (denoted as [R]), such that (1) each node S₁ holds a share Rᵢ of [R], and (2) no node knows the value of R. For example, in one set of embodiments nodes S₁, S_{N} can receive their respective shares R₁, . . . , R_{N} from a trusted third-party. In another set of embodiments, two nodes (e.g., S₁ and S₂) can create sharings of randomly selected values Y and Z where Y is only known to S₁, Z is only known to S₂, and random value R=Y+Z. Nodes S₁ and S₂ can then distribute the shares of [Y] and [Z] to the other nodes and each node can compute its share of [R] as the sum of its shares of [Y] and [Z]. With this method, no single node will know both Y and Z and thus cannot learn R.

Upon generating/establishing [R], each node S₁ can send its respective share Rᵢ to client C via C's communication endpoint address ADDR (step 206).

At step 208, client C can receive the shares of [R] at ADDR and can reconstruct R using the received shares. Client C then generate a new T-out-of-N sharing of the reconstructed value of R (denoted as [R′]) comprising shares R′₁, . . . , R′_{N} (step 210) and can send share R′ᵢ to each node S₁ (step 212).

At step 214, nodes S₁, S_{N} can receive shares R′₁, . . . , R′_{N} and can securely compute, via a secure multiparty computation (MPC) protocol, [Δ]=[Q]·([R]−[R′]), where [Q] is a new sharing of a non-zero secret random value Q that is generated by the nodes for this specific registration request. As mentioned previously, the use of Q in this computation prevents the nodes from learning anything regarding R in the scenario where R′ is different from R and thereby bolsters the privacy of the solution. In alternative embodiments where this additional degree of privacy preservation is not needed, the nodes can simply compute [Δ]=[R]−[R′].

Nodes S₁, . . . , S_{N} can thereafter collectively reconstruct/reveal delta value Δ using their shares of [Δ] (step 216) and each node S₁ can check whether Δ=0 (step 218). If the answer is yes (which means R=R′), node S₁ can conclude that client C correctly re-shared R at step 208 and thus is the owner of communication endpoint address ADDR. Accordingly, node S₁ can create and store a local registration entry Eᵢ for client C that includes ADDR and the node's share Rᵢ of [R] (step 220).

On the other hand, if the answer at step 218 is no, node S₁ can conclude that client C is not the owner of the communication endpoint address (or otherwise re-shared a value R′ that is different from R in violation of the registration procedure). In this case, node S₁ can take no action for registering client C (step 222).

Finally, at step 224, client C can store R as its authentication credential for logging into system 104 and workflow 200 can end.

### 4. Distributed Authentication Workflow

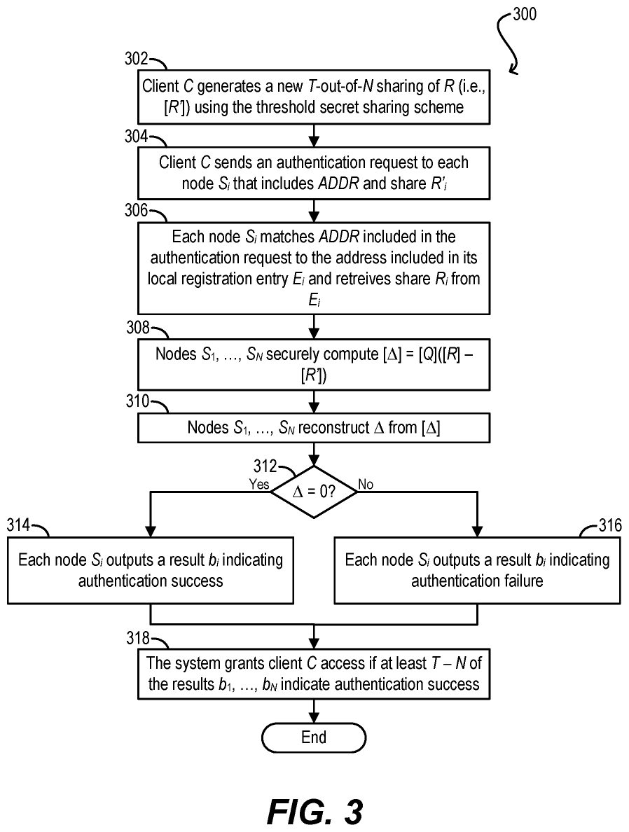

FIG. 3 depicts a workflow 300 that provides additional details regarding the processing that may be performed by client C and nodes S₁, . . . , S_{N} of FIG. 1 for implementing distributed authentication via threshold secret sharing according to certain embodiments. Workflow 300 assumes that client C has registered with system 104 via workflow 200 and thus C holds R and each (uncorrupted) node Sᵢ holds a local registration entry Eᵢ comprising C's communication endpoint address ADDR and that node's share Rᵢ of [R].

Starting with steps 302 and 304, Client C can generate a new T-out-of-N sharing of R (denoted as [R′]) comprising shares R′₁, . . . , R′_{N} and can send an authentication request to each node Sᵢ that includes ADDR and share R′ᵢ. In various embodiments, sharing [R′] is not the same as sharing [R′] described in distributed registration workflow 200; instead, [R′] here is a completely new sharing of R that is created by client C for this specific authentication request.

At step 306, each node Sᵢ can receive the authentication request, match the communication endpoint address ADDR included in the authentication request to the address identified in its local registration entry Eᵢ, and retrieve share Rᵢ from E. Nodes S₁, . . . , S_{N} can then securely compute, via an MPC protocol, [Δ]=[Q] ([R]−[R′]) using the shares of R′ included in the received authentication requests and the shares of [R] retrieved from the local registration entries (step 308). As discussed with respect to workflow 200, [Q] is a new sharing of a non-zero secret random value Q that is generated by the nodes for this specific authentication request and is used to obfuscate the true value of [R] — [R′] in cases where R≠R′, thereby preventing the nodes from learning anything regarding R.

At steps 310 and 312, nodes S₁, . . . , S_{N} can collectively reconstruct/reveal delta value Δ using their shares of [Δ] and each node Sᵢ can check whether Δ=0. If the answer is yes (which means R=R′), node Sᵢ can conclude that client C has been successfully authenticated and can output a result bᵢ indicating authentication success (step 314).

On the other hand, if the answer at step 312 is no, node Sᵢ can conclude that client C has not been successfully authenticated. In this case, node Sᵢ can output a result bᵢ indicating authentication failure (step 316).

Finally, at step 318, system 104 can grant client C access if at least N— T nodes have output a result indicating authentication success per step 314 and workflow 300 can end.

Certain embodiments described herein can employ various computer-implemented operations involving data stored in computer systems. For example, these operations can require physical manipulation of physical quantities—usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any storage device, based on any existing or subsequently developed technology, that can store data and/or computer programs in a non-transitory state for access by a computer system. Examples of non-transitory computer readable media include a hard drive, network attached storage (NAS), read-only memory, random-access memory, flash-based nonvolatile memory (e.g., a flash memory card or a solid state disk), persistent memory, NVMe device, a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method comprising:
receiving, by a set of N nodes in a computing system, a registration request from a client, the registration request including a communication endpoint address of the client;
generating, by the set of N nodes, a T-out-of-N sharing [R] of a secret random value R using a threshold secret sharing scheme, wherein T corresponds a maximum number of nodes in the set of N nodes that may be corrupted by an adversary;
sending, by each node i in the set of N nodes, a share Rᵢ of [R] to the client at the communication endpoint address;
receiving, by said each node i in the set of N nodes, a share R′ᵢ of a T-out-of-N sharing [R′] from the client, wherein [R′] is generated by the client using the threshold secret sharing scheme based on a value R′ reconstructed from [R];
computing, by the set of N nodes using their shares of [R] and [R′], a delta value Δ reflecting a difference between R and R′; and
upon determining that Δ equals zero, storing, by said each node i in the set of N nodes, a registration entry Eᵢ for the client that includes the communication endpoint address and Rᵢ.

2. The method of claim 1 further comprising, upon determining that Δ does not equal zero:
taking, by each node i in the set of N nodes, no action for registering the client/

3. The method of claim 1 wherein the client stores R as an authentication credential for logging into the computing system.

4. The method of claim 1 wherein T is less than N/3.

5. The method of claim 1 wherein Δ equals a difference between R and R′ multiplied by a secret random value Q that is unique to the registration request.

6. The method of claim 1 wherein the computing comprises:
computing a sharing [Δ] of Δ based on [R] and [R′] using a secure multiparty computation (MPC) protocol; and
reconstructing Δ from [Δ].

7. The method of claim 1 further comprising:
receiving, by said each node i in the set of N nodes, an authentication request from the client, the authentication request including the communication endpoint address and a share R″ᵢ of a T-out-of-N sharing [R″], wherein [R″] is generated by the client using the threshold secret sharing scheme based on R;
matching, by said each node i in the set of N nodes, the communication endpoint address in the authentication request to the previously stored registration entry Eᵢ;
retrieving, by said each node i in the set of N nodes, Rᵢ from Eᵢ;
computing, by the set of N nodes using their shares of [R] and [R″], a delta value Δ′ reflecting a difference between R and R″; and
upon determining that Δ′ equals zero, outputting, by said each node i in the set of N nodes, a result indicating that the client is successfully authenticated.

8. A non-transitory computer readable storage medium having stored thereon program code executable by a set of N nodes in a computing system, the program code embodying a method comprising:
receiving a registration request from a client, the registration request including a communication endpoint address of the client;
generating a T-out-of-N sharing [R] of a secret random value R using a threshold secret sharing scheme, wherein T corresponds a maximum number of nodes in the set of N nodes that may be corrupted by an adversary;
sending, by each node i in the set of N nodes, a share Rᵢ of [R] to the client at the communication endpoint address;
receiving, by said each node i in the set of N nodes, a share R′ᵢ of a T-out-of-N sharing [R′] from the client, wherein [R′] is generated by the client using the threshold secret sharing scheme based on a value R′ reconstructed from [R];
computing a delta value Δ reflecting a difference between R and R′; and
upon determining that Δ equals zero, storing, by said each node i in the set of N nodes, a registration entry Eᵢ for the client that includes the communication endpoint address and R.

9. The non-transitory computer readable storage medium of claim 8 wherein the method further comprises, upon determining that Δ does not equal zero:
taking, by each node i in the set of N nodes, no action for registering the client.

10. The non-transitory computer readable storage medium of claim 8 wherein the client stores R as an authentication credential for logging into the computing system.

11. The non-transitory computer readable storage medium of claim 8 wherein T is less than N/3.

12. The non-transitory computer readable storage medium of claim 8 wherein Δ equals a difference between R and R′ multiplied by a secret random value Q that is unique to the registration request.

13. The non-transitory computer readable storage medium of claim 8 wherein the computing comprises:
computing a sharing [Δ] of Δ based on [R] and [R′] using a secure multiparty computation (MPC) protocol; and
reconstructing Δ from [Δ].

14. The non-transitory computer readable storage medium of claim 8 wherein the method further comprises:
receiving, by said each node i in the set of N nodes, an authentication request from the client, the authentication request including the communication endpoint address and a share R″ᵢ of a T-out-of-N sharing [R″], wherein [R″] is generated by the client using the threshold secret sharing scheme based on R;
matching, by said each node i in the set of N nodes, the communication endpoint address in the authentication request to the previously stored registration entry Eᵢ;
retrieving, by said each node i in the set of N nodes, Rᵢ from Eᵢ;
computing a delta value Δ′ reflecting a difference between R and R″; and
upon determining that Δ′ equals zero, outputting, by said each node i in the set of N nodes, a result indicating that the client is successfully authenticated.

15. A node in a set of N nodes that collectively make up a computing system, the node comprising:
a processor; and
a non-transitory computer readable medium having stored thereon program code that, when executed, causes the processor to:
receive a registration request from a client, the registration request including a communication endpoint address of the client;
generate, in conjunction with other nodes in the set of N nodes, a T-out-of-N sharing [R] of a secret random value R using a threshold secret sharing scheme, wherein T corresponds a maximum number of nodes in the set of N nodes that may be corrupted by an adversary;
send a share Rᵢ of [R] to the client at the communication endpoint address;
receive a share R′ᵢ of a T-out-of-N sharing [R′] from the client, wherein [R′] is generated by the client using the threshold secret sharing scheme based on a value R′ reconstructed from [R];
compute, in conjunction with the other nodes, a delta value Δ reflecting a difference between R and R′; and
upon determining that Δ equals zero, store a registration entry Eᵢ for the client that includes the communication endpoint address and R.

16. The node of claim 15 wherein the program code further causes the processor to, upon determining that Δ does not equal zero:
take no action for registering the client.

17. The node of claim 15 wherein the client stores R as an authentication credential for logging into the computing system.

18. The node of claim 15 wherein T is less than N/3.

19. The node of claim 15 wherein Δ equals a difference between R and R′ multiplied by a secret random value Q that is unique to the registration request.

20. The node of claim 15 wherein the program code that causes the processor to compute Δ comprises program code that causes the processor to:
compute a sharing [Δ] of Δ based on [R] and [R′] using a secure multiparty computation (MPC) protocol; and
reconstruct Δ from [Δ].

21. The node of claim 15 wherein the program code further causes the processor to:
receive an authentication request from the client, the authentication request including the communication endpoint address and a share R″ᵢ of a T-out-of-N sharing [R″], wherein [R″] is generated by the client using the threshold secret sharing scheme based on R;
match the communication endpoint address in the authentication request to the previously stored registration entry Eᵢ;
retrieve Rᵢ from Eᵢ;
compute, in conjunction with the other nodes, a delta value Δ′ reflecting a difference between R and R″; and
upon determining that Δ′ equals zero, output a result indicating that the client is successfully authenticated.
